(19) United States
(12) Patent Application Publication
(10) Pub. No.: US 2004/0088365 A1
(43) Pub. Date: May 6, 2004

(54) Service information model mapping with shared directory tree representations

(75) Inventors: David Gadbois, Austin, TX (US); Mark Wahl, Austin, TX (US)

Correspondence Address: ZAGORIN O'BRIEN & GRAHAM, L.L.P., 7600B N. CAPITAL OF TEXAS HWY., SUITE 350, AUSTIN, TX, 78731, US

(73) Assignee: Sun Microsystems, Inc.

(21) Appl. No.: 10/283,928

(22) Filed: Oct. 30, 2002

(51) Int. Cl. G06F 15/167; G06F 7/00; G06F 17/30

(52) U.S. Cl. 709/213; 707/10

(57) ABSTRACT

A method of manipulation of data information trees, and software and systems therefore, allow the mapping of information models for support of markup-oriented registry services. For example, a first business entity may provide a service. Service information regarding the service is stored in a hierarchical directory information tree at a node corresponding to the business entity. Another business entity may desire to provide the service of the first business entity. Service projection information regarding the service offered by the first entity is stored in a hierarchical directory information tree at a node corresponding to the second business entity.

### BACKGROUND

1. Field

The present invention relates to information processing systems, and, more particularly, to directory tree representations in the context of such systems (e.g., information model mapping for support of markup-oriented registry services using shared directory tree representations).

2. Description of the Related Art

Directory services can be used to provide information regarding business organizations. Business organizations typically offer services which are recorded in the directory services. Many businesses offer services through other businesses. Accordingly, an efficient means of recording proxy business services is needed.

### BRIEF DESCRIPTION

The present invention relates to information processing systems, and, more particularly, to directory tree representations in the context of such systems (e.g., information model mapping for support of markup-oriented registry services using shared directory tree representations).

In one embodiment, an apparatus includes a directory information tree encoded in a memory. The directory information tree (DIT) includes first and second entity nodes corresponding to first and second entities, respectively. The DIT also includes service nodes and service projection nodes. For example, the DIT may include a first entity service node corresponding to the first entity node in the directory information tree and a second entity service projection node corresponding to the second entity node in the directory information tree. The first entity service node includes information regarding a service offered by the first entity. The second entity service projection node includes information regarding the first entity service node. In a further embodiment, the apparatus includes a directory information processing system, the directory information processing system comprising the memory, the directory information tree, and directory server software for accessing the directory information tree in the memory responsive to messages from another information processing system. In yet a further embodiment, the apparatus includes a directory service, the directory service including at least one directory server system including the directory information processing system and at least one registry server coupled to the directory server system. The registry server may be coupled to access at least one of the first entity service node and the second entity service projection node in the directory information tree. The at least one registry server may be coupled to the directory server system to initiate modification of at least one of the first entity service node and the second entity service projection node in the directory information tree. The at least one registry server may also be coupled to receive messages from directory service users and to access the directory server system responsive to the messages from the directory service users. In yet a further embodiment, the first and second entities are commercial entities, and the first entity service node includes information regarding a business service offered by the first entity.

In another embodiment, a method of processing information regarding services offered through a plurality of entities is provided. The method includes various steps for configuring a directory information tree or DIT. For example, a DIT is configured to store service information in relation to a first entity and service projection information in relation to a second entity (e.g., among other entities). The service information regards a service to be provided directly by the first entity, and the service projection information regards the service to be provided by the first entity. Other functionality may be performed in additional steps in further embodiments as described in greater detail below.

In another embodiment, an apparatus for processing information regarding services offered through a plurality of entities is provided. The apparatus includes software modules encoded on a computer readable medium. The software modules include code for configuring a directory information tree to store service information in relation to a first entity and service projection information in relation to a second entity. The service information regards a service to be provided directly by the first entity, and the service projection information regards the service to be provided by the first entity. Other software modules may be included, and such software modules may or may not be submodules of other modules or may share some functionality or code with other modules. In a further embodiment, The apparatus further includes the directory information tree encoded in a memory (which may or may not be the aforementioned computer readable medium. The directory information tree is configurable to store first and second entity nodes corresponding to the first and second entities, respectively, a first entity service node corresponding to the first entity, and a second entity service projection node corresponding to the second entity.

The foregoing provides a brief description, and to a certain extent a summary, of certain embodiments discussed in greater detail in the detailed description below. Consequently, the foregoing contains, by necessity, simplifications, generalizations and omissions of detail. Consequently, those skilled in the art will appreciate that the foregoing summary is illustrative only and that it is not intended to be in any way limiting of the invention. Other aspects, inventive features, and advantages of the present invention, as defined solely by the claims, may be apparent from the detailed description set forth below.

### BRIEF DESCRIPTION OF THE DRAWINGS

The present invention may be better understood, and its numerous objects, features, and advantages made apparent to those skilled in the art, by referencing the accompanying drawings. The use of the same reference symbols in different drawings indicates similar or identical items.

FIG. 1 is a block diagram of a network including one embodiment of a business registry processing system according to the invention.

FIG. 2 is a block diagram illustrating the registry of FIG. 1.

FIG. 3 is a flowchart showing a method of processing publisher assertions using the registry of FIG. 1.

FIG. 4 is a flowchart showing a method of saving a business in the registry of FIG. 1.

FIG. 5 is a flowchart showing a method of saving a service in the registry of FIG. 1.

FIG. 6 is a flowchart showing a method of finding a business in the registry of FIG. 1.

FIG. 7 is a flowchart showing a method of finding a service in the registry of FIG. 1.

FIG. 8 is a flowchart showing a method of getting business details from the registry of FIG. 1.

### DETAILED DESCRIPTION

The following discussion is intended to provide a detailed description of at least one example of the invention and should not be taken, to be limiting of the invention itself. Rather, any number of variations may fall within the scope of the invention which is properly defined in the claims following this description.

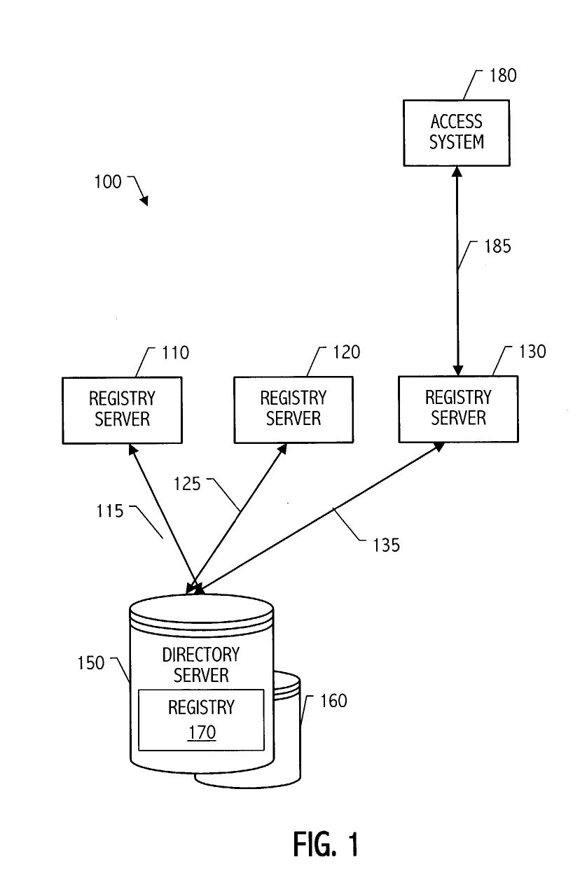

FIG. 1 is a block diagram of an information processing network 100 for providing a registry service such as a Universal Description, Discover and Integration (UDDI) business registry. (The UDDI specification entitled “UDDI Version 3.0” which was published Jul. 19, 2002 and authored by Tom Bellwood, Luc Clement, David Ehnebuske, Andrew Hately, Maryann Hondo, Yin Leng Husband, Karsten Januszewski, Sam Lee, Barbara McKee, Joel Munter, and Claus von Riegen, and which is incorporated herein by reference in its entirety, is known to those of ordinary skill in the art and is commonly available via the Internet, for example through the Organization for the Advancement of Structured Information Standards (OASIS) at www.oasis-open.org and at www.uddi.org.) Network 100 includes registry servers 110, 120 and 130, directory servers 150 and 160, and access system 180. In the embodiment shown, directory servers 150 and 160 are collocated, although collocation is not required. Also in the embodiment shown, directory servers 150 and 160 are coupled to registry server 110 via network coupling 115, to registry server 120 via network coupling 125, and to registry server 130 via network coupling 135. Other couplings may be used, as appropriate. Registry server 130 is coupled to access system 180 via coupling 185.

Access system 180 is representative of any access point to network 100. As such, access system 180 may be any appropriate type of information processing system, for example, which allows administrators, clients, or any other type of user access to a registry server. In one embodiment, access system 180 is a personal computer or workstation. In the embodiments described herein, access system 180 may be an access point for a client user, a publishing entity or any other party, and as such, access system 180 is representative of a variety of access points to network 100. Thus, although only one access system is shown in FIG. 1, it is expected that many such access points will be used. Also, although some of the following discussion describes various entities accessing registry server 130 and directory server 150 from access system 180, access to the network 100 directory service may be through other access systems, registry servers and directory servers.

In the embodiment shown, redundant registry servers are deployed to enhance performance and/or reliability. Registry server 130 is a server system for receiving, processing and responding to directory service request messages sent by directory service users. In one embodiment, registry server 130 is a software server operating on a compatible hardware platform. In another embodiment, registry server 130 is a computer system. Each registry server is coupled to one or more directory servers such as directory servers 150 and 160. Additional, replicated directory servers may also be added to further increase reliability. Each directory server is a software server and/or computer system physically or virtually including or coupled to one or more persistent data storage areas or devices. In the embodiment shown, the storage is represented as being integral within each directory server for simplicity of presentation. Directory server 150 provides a database for storing directory service information, and may take any appropriate form which provides sufficient storage space and processing hardware and software to access the storage space.

One type of directory server is a Sun ONE directory server. The Sun ONE Directory Server is a software product that provides a central repository for storing and managing identity profiles, access privileges and application and network resource information. Information stored in the Sun ONE Directory Server can be used for the authentication and authorization of users to enable secure access to enterprise and Internet services and applications.

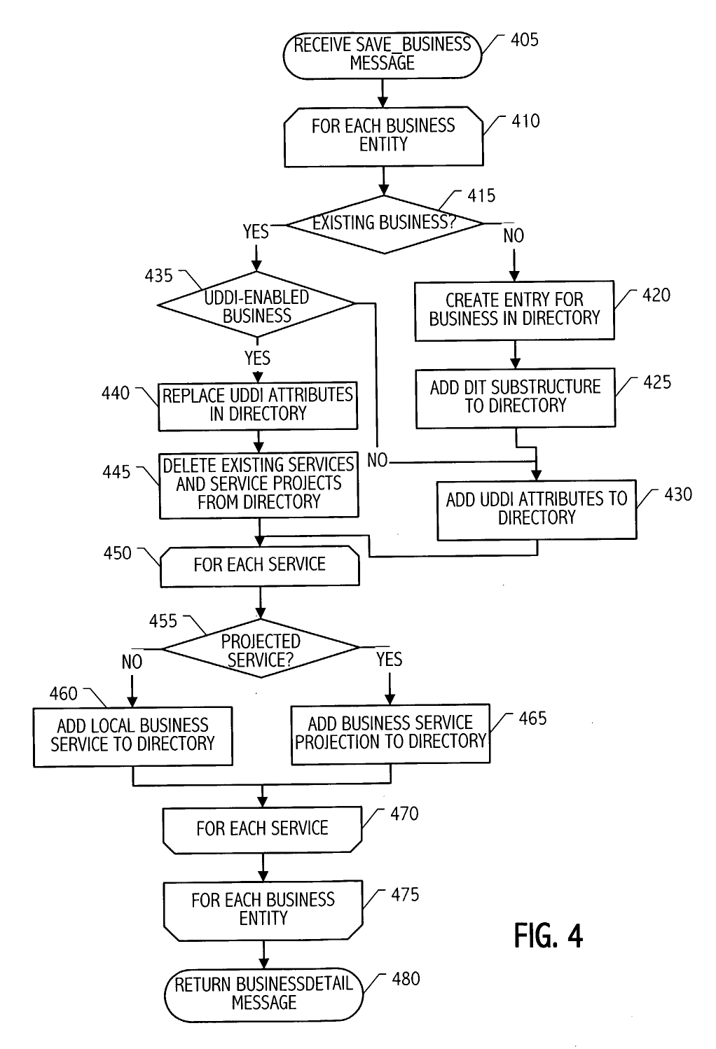

One role of a directory service is to support the storage and retrieval of data. Generally speaking, in operation, a user at access system 180 accesses registry server 130 by sending an initial message to registry server 130 via network coupling 185. See, e.g., sent messages 405, 510, 605, 710 and 805 in FIGS. 4-8, respectively. Then, depending on the content of the message, registry server 130 accesses directory server 150, for example, to perform certain functions indicated by the message. If information stored at directory server 150 is changed, the changed information is then made available to other registry servers such as registry servers 110 and 120. The functionality of various operations described herein is typically accomplished by information processing at registry server 130 and/or directory server 150 as appropriate, and/or by an exchange of one or more messages passing between registry server 130 and directory server 150. For example, registry server 130 typically queries directory server 150, analyzes information received from directory server 150, and instructs directory server to make changes to registry 170 if appropriate given the nature of the initially received message from access system 180. For further example, directory server 150 typically receives queries from registry server 130, queries registry 170 responsive thereto, provides information to registry server 130, and makes any changes appropriately requested by registry server 130. Typically, this processing and message exchange occurs before a result message responsive to the initial message from the user is provided to the user at access server 180 by registry server 130. Exemplary result messages are illustrated at 480, 580, 660, 790 and 880 in FIGS. 4-8, respectively.

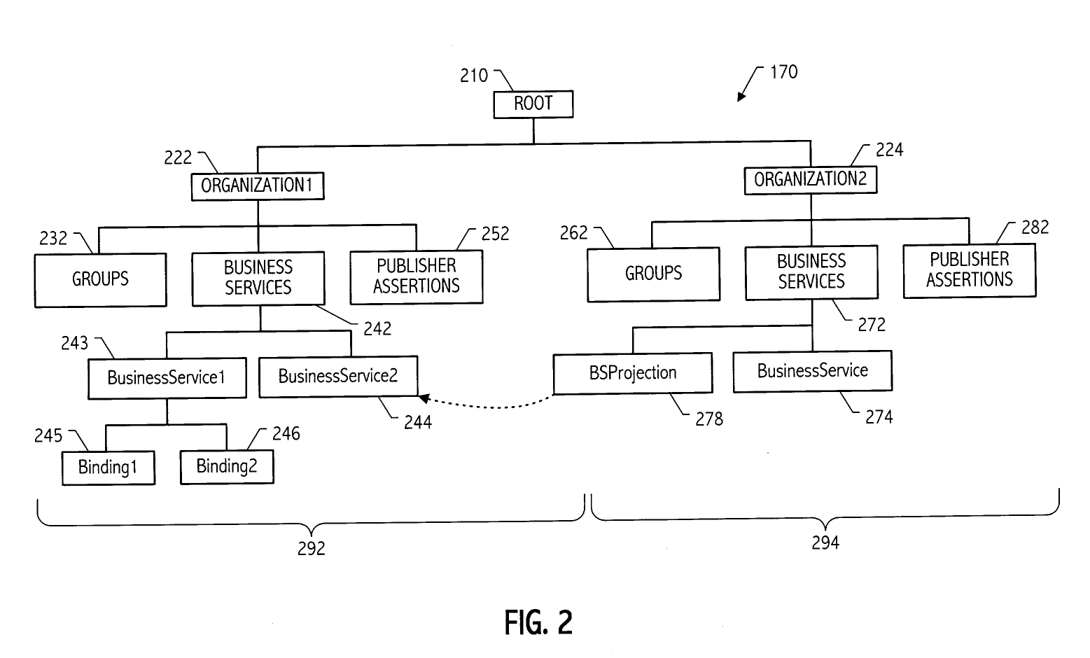

Directory server 150 stores information for access by the user through this process. Information stored on directory server 150 may be stored in a tree-like structure. This mirrors the tree model used by many file systems and is sometimes referred to herein as a directory, directory tree or a directory information tree (DIT). One example of such a DIT, registry 170, is shown in FIG. 2. As its name implies, a DIT provides a directory of information in a data tree format. The tree is populated by a plurality of nodes at which various types of information are stored such as specialized information entries or information keys. In one embodiment, registry 170 is a Lightweight Directory Access Protocol (LDAP) directory in which object classes are used to define each node therein.

In the embodiment shown in FIG. 2, a root node is maintained by the host system (e.g., directory server 150), and is represented by root node 210. Of course, each directory server may maintain more than one DIT, and therefore more than one root node. A first tier or set of interior nodes coupled to the root node include a set of nodes representative of various entities. As used herein, entities includes any type of individual or organization capable of providing, or with a purpose to provide, directly or through other entities, a service to other entities, and may include, for example, individuals, partnerships, corporations, institutions, other commercial, academic, religious, governmental or military entities, real or virtual, or any other individual or organization recognizable as such by a directory service. For example, an Organization1 is represented at node 222, and Organization2 is represented at node 224. Each organizational node is a “root” node for an organizational sub-tree such as sub-trees 292 and 294 shown in FIG. 2.

Typically, Organization1 and Organization2 are businesses or other types of commercial entities, but the organizations represented in the organizational tier may be any type of entity such as governmental, institutional, academic and personal, to name a few. For purposes of simplification, the embodiments are often described hereafter in terms of businesses, but one of ordinary skill in the art will appreciate that such description is not necessarily limited to commercial environments, and that the described businesses and their attributes may be replaced by any type of organization and its respective attributes.

Each organizational node is typically coupled to a number of interior sub-nodes which contain further information, or links to further information, regarding the respective organization. For example, Organization1 node 222 is coupled to Groups node 232, BusinessServices node 242 and PublisherAssertions node 252. Organization2 node 224 is coupled to Groups node 262, BusinessServices node 272 and PublisherAssertions node 282. Other types of nodes may also be used, but are not shown here to avoid obfuscation of the embodiment.

Groups node 232 is exemplary of any of a variety of types of nodes which provide information regarding the organization to which the node is coupled. In this case, Groups node 232 includes information or includes branching points to such information regarding various groups of or within Organization1. For simplicity of presentation, the group branching points are not shown in FIG. 2.

PublisherAssertions node 252 in Organization1 sub-tree 292 provides a branching point to nodes (not shown) which include information regarding relations between Organization1 and other organizations. Such nodes are further described in U.S. patent application Ser. No. 10/184,234 (attorney docket No. 004-7438), entitled “Information Model Mapping with Shared Directory Tree Representations,” filed on Jun. 28, 2002, naming David G. Gadbois and Mark Wahl as inventors, and which is incorporated by reference herein in its entirety.

BusinessServices node 242 provides a branching point for sub-nodes which include information regarding business services of Organization1 such as BusinessService1 node 243 and BusinessService2 node 244. Although business services are discussed with reference to FIG. 2, other, non-business services may be offered by business organizations or other types of organizations, and such services may be stored in sub-trees associated with the appropriate business or other organizational nodes. BusinessService1 is accessible via information represented at Binding1 node 245 and at Binding2 node 246. One exemplary type of binding is a uniform resource locator (URL).

Similarly, registry 170 includes sub-tree 294 with sub-nodes of Organization2 node 224 which include information regarding groups (e.g., node 252 and subnodes not shown) and business services (e.g., node 272 and subnodes not shown), and publisher assertions (e.g., node 282 and subnodes not shown) and other informational nodes of Organization2.

BusinessServices node 272 provides a branching point for sub-nodes which include information regarding business services of Organization2 such as BusinessService node 274 and BSProjection node 278. The business service of node 274 is accessible via information represented at various bindings (not shown) coupled to BusinessService node 274.

In the example shown in FIG. 2, Organization2 makes certain business services available which are actually provided by Organization1. Consequently, a business service projection (BSProjection) node 278 is provided as a sub-node to Organization2. BSProjection node 278 includes information linking to a business service offered by another business entity, such as Organization2. This is indicated by linking information in BSProjection 278 which links to BusinessService2 node 244 of Organization1. For example, BSProjection node 278 may include a service key which identifies a service provided by another organization and which may be used to locate and retrieve a service entry within a sub-tree of the other organization.

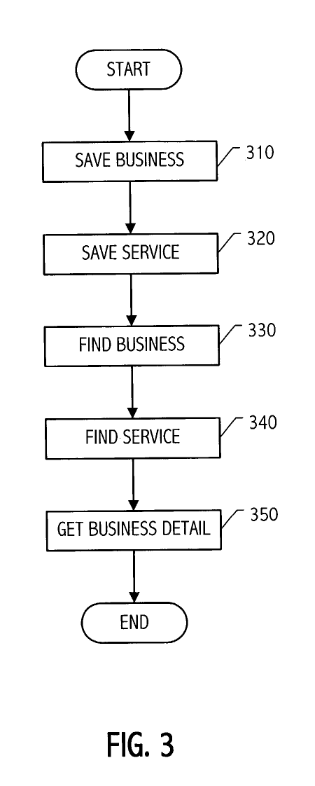

FIG. 3 is a flowchart showing an exemplary flow in which various organization information including service information is processed using registry 170. Various information related to a particular organization, including information regarding services offered by the particular organization and services offered by another organization through the aforementioned particular organization, is processed. There are at least two classes of processing operations, the “publish API” and the “inquiry API”. The publish API assumes registration and requires authentication. The inquiry API has no registration or authentication requirements. At least one of the publish API operations must be completed for an inquiry API operation to return meaningful results or to complete without errors occurring. Referring to FIG. 3, operations 310 and 320 are in the publish API class, and operations 330, 340 and 350 are in the inquiry API class.

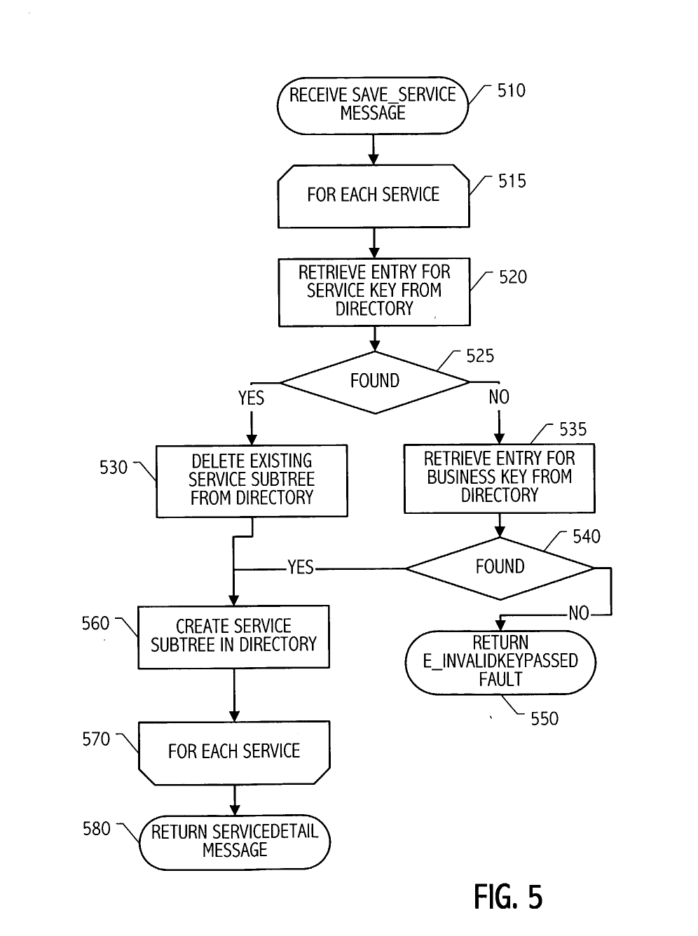

Referring to FIG. 3, information regarding an organization such as a business is saved during operation 310. Various information related to a particular business is saved, including information regarding business services offered by the particular business and business service offered by another business through the particular business, if applicable. Such information regarding the services offered by an organization may be changed or new information may be saved during operation 320. An exemplary save business information flow is discussed below with reference to FIG. 4, and an exemplary save services information flow is discussed below with reference to FIG. 5.

In order to properly set up a business service projection, two of operations 310 and/or 320, or two portions of one of those operations must performed properly. For example, a business service for a first business must be saved, and the business service projection of a second business referring to the business service of the first business must be saved for a service listing for the projecting organization (the second business) to be complete. Once both operations are completed for the same service, then the respective service listing for the projecting organization is said to be complete. Regardless, once a service is listed under the providing organization, that service listing is complete. More than one service projection node may reference a particular business service node.

Services are accessed by clients during any of a variety of operations including inquiry API operations 330, 340 and/or 350. In the present embodiment, the client may or may not be registered and/or authenticated prior to accessing the information stored in registry 170. For example, a user may access information stored in registry 170 on directory server 150 via access system 180 and registry server 130. Any of a variety of types of information accesses may be implemented.

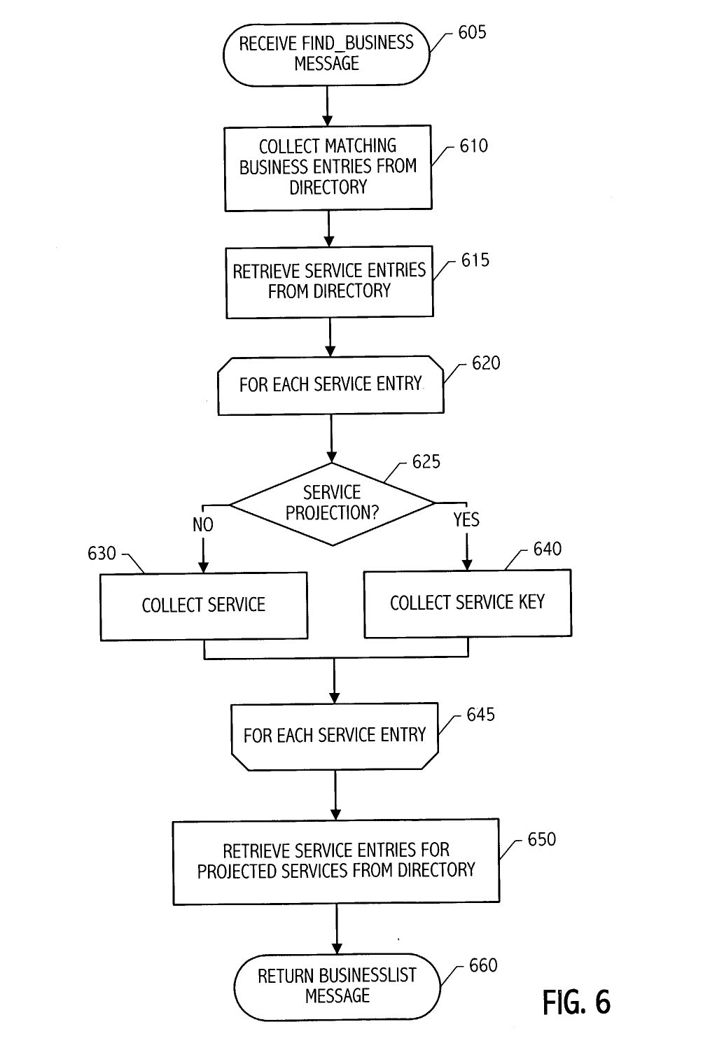

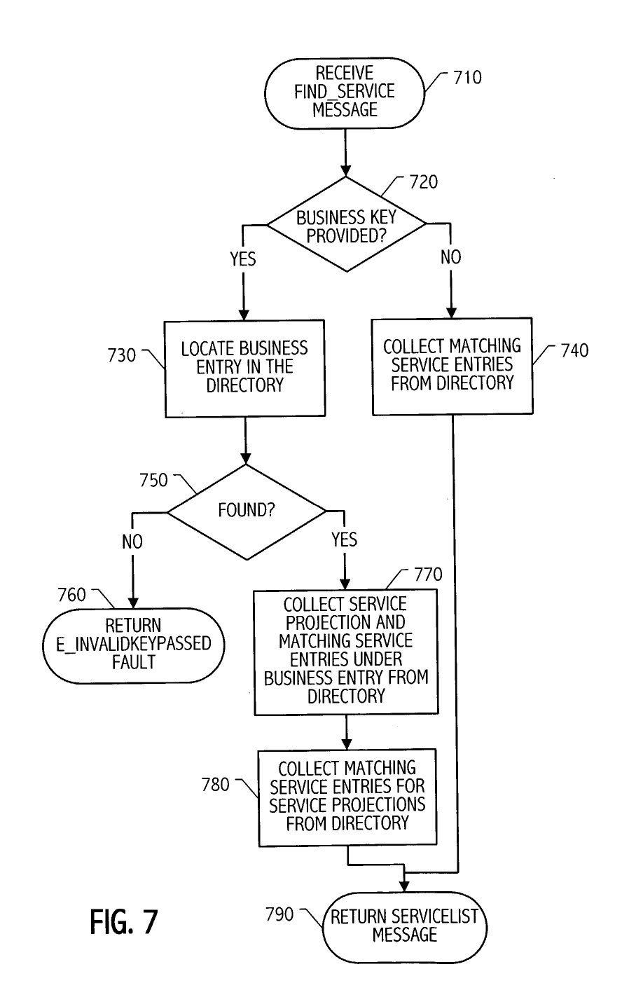

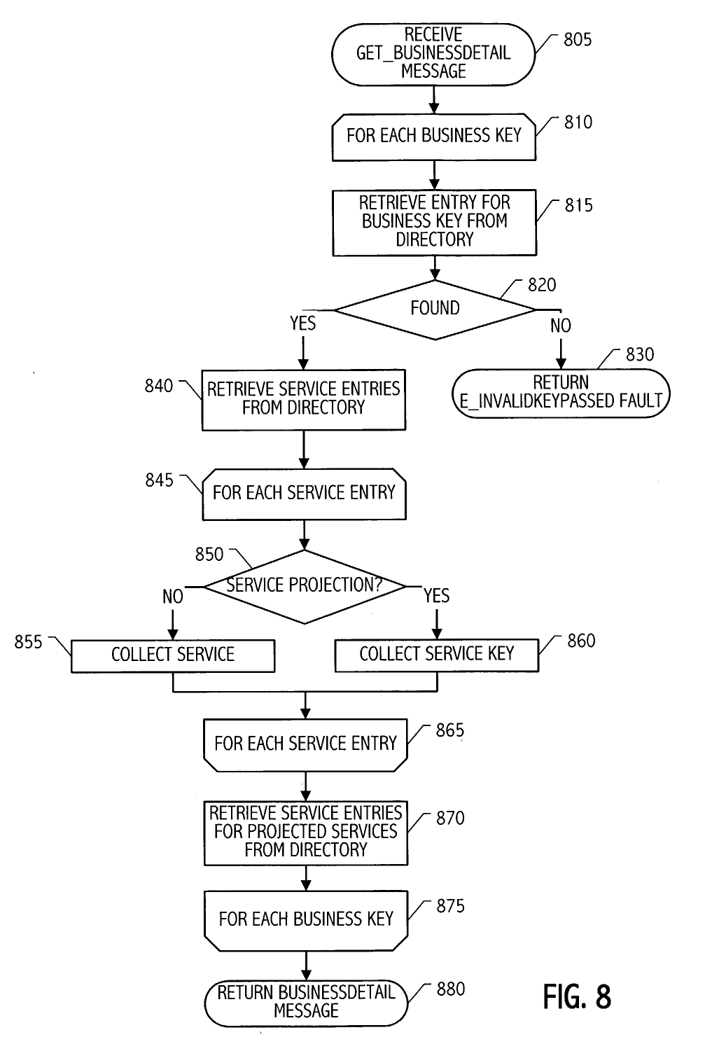

Some exemplary client access flows are represented by operations 330, 340 and 350 of FIG. 3. During find business operation 330, a client accesses registry 170 to find a business. This operation may be used, for example, to find all services offered by or otherwise made available by one or more identified businesses. Operation 330 is discussed in further detail below with reference to FIG. 6. During find service operation 340, a client accesses registry 170 to find a particular service. This operation may be used, for example, to find one or more businesses which offer one or more identified services, or to find out if a particular business offers such services. Operation 340 is discussed in further detail below with reference to FIG. 7. During get business detail operation 350, a client accesses registry 170 to get details of a particular business. This operation may be used, for example, to find the services offered by one or more businesses. Operation 350 is discussed in further detail below with reference to FIG. 8.

As shown in FIG. 3 operations 330, 340 and 350 occur in that particular order, and occur after operation 320. While this ordering is helpful to illustrate a successful life cycle of an exemplary service projection, such an ordering of operations is not necessarily required, and may in fact be modified in actual practice.

FIG. 4 is a flowchart showing an exemplary flow in which a business is saved in registry 170. A save_business message is received at operation 405. For example, a directory service user may use access system 180 to send a message to registry server 130 to save information about a business organization in registry 170 of directory server 150. A save_business message may include information regarding one or more businesses, and for each business, one or more services or service projections. For each business entity identified in the message, operations 410-475 are executed to save the information in registry 170. Operations 410-475 may be visualized as an execution flow loop for purposes of explanation. However, although certain functionality of the directory service of network 100 may be described herein in terms of functional loops, various embodiments will perform the functionality of the described iterative loop in parallel and/or using multiple iterations of objects made for the purpose of completing the overall functionality of the described loop.

The directory service determines if the currently identified and selected business already has an entry in registry 170 during existing business decision 415. If an entry for the business does not exist in registry 170, the directory service continues processing the message at create entry operation 420. If an entry for the business does exist in registry 170, the directory service continues processing the message at UDDI decision operation 435.

If the business does not have an entry in registry 170 at existing business decision 415, an entry is created for the business during create entry operation 420. After the business entry is created, a business organization directory tree substructure is added to registry 170 during add DIT substructure operation 425. For example, a DIT organizational sub-tree is added for the business. After the substructure is added to registry 170, UDDI attributes are added to registry 170. Groups are part of the substructure and are added at operation 425. Nodes for publisher assertions and services entries are added to registry 170 at operation 430. After the UDDI attributes are added, the directory service continues processing in accordance with the save_business message at operation 450 with respect to each service as applicable.

If the business is determined to already have an entry in registry 170 at existing business decision operation 415, the directory service determines if the entry is UDDI enabled during UDDI decision operation 435. If the entry is determined to not be UDDI enabled during UDDI decision operation 335, UDDI attributes are added to registry 170 during add UDDI attributes operation 430 discussed above. After the UDDI attributes are added, the directory service continues processing in accordance with the save_business message at operation 450 with respect to each projected service, if applicable.

If the entry is determined to be UDDI enabled during UDDI decision operation 435, the directory service replaces the UDDI attributes in the directory with new attributes from the message during replace UDDI attributes operation 440. For example, registry server 130 sends a message to directory server 150 with instructions to change the attributes.

Operations 450-470 are completed for each service applicable to each business entity. The directory service determines whether the service entry in the save_business message is a projected service during projected service decision 455. If so, a business service projection is added to registry 170 during operation 465. If not, a local business service is added to registry 170 during operation 460. After each of operations 460 and 465, directory service processing continues and completes for each service and for each business as indicated at 470 and 475 in FIG. 4. A businessdetail message is returned at operation 480 to provide the results, for example, to a user at access system 180 via registry server 130. The results may indicate, for example, a successful saving of each service of each business, if applicable.

FIG. 5 is a flowchart showing an exemplary flow in which a service is saved in registry 170. A save_service message is received at operation 510. For example, a directory service user may use access system 180 to send a message to registry server 130 to save service information about a business organization in registry 170 of directory server 150. A save_business message may include information regarding one or more businesses, and for each business, one or more services or service projections. For each service identified in the message, operations 515-570 are executed to save the information in registry 170.

During operation 520, an entry for a service key corresponding to information in the save_message is retrieved from registry 170. A service key includes information identifying a directory tree node location of a remote service offered by another business and made available by the business under which the service key stored. If the service key is found in registry 170 during decision 525, the existing service subtree is deleted from registry 170 so that it can replaced with a new service subtree in registry 170 during operation 560. The new service subtree includes information from the save_service message. Upon successful completion of saving the service, processing of the service is complete at end loop designation 570, and a message including the details of the service saving process are returned at return servicedetail message 580. The message is sent to access system 180, for example, via registry server 130.

If the service key is not found during decision 525, the business entry for a business key is retrieved from the directory during operation 535. If a business key is not found during decision 535, an error is indicated at return e_invalidkeypassed fault operation 550. If a business key is found during decision 535, the existing service subtree is deleted from registry 170 during operation 560 and processing continues as described above.

FIG. 6 is a flowchart showing an exemplary flow in which a business is found in registry 170. A find_business message is received at operation 605. For example, a directory service user may use access system 180 to send a message to registry server 130 to find an organization such as a business, along with the services offered by the business. Registry server in turn communicates with directory server 150 to find the business in registry 170. A find_business message may include information which can be used to locate one or more businesses. For example, a find_business message may include information identifying one or more services, and the businesses that offer such services may then be found responsive to the find_business message.

After the find_business message is received during operation 605, business entries are collected from registry 170. Business entries (e.g., information stored at a business organization node) are selected which match information describing the business (e.g., an organizational name) in the find_business message. For example, registry server sends a message to registry 170 requesting information regarding all entries in registry 170 which match the business description, and directory server 150 queries registry 170 accordingly and returns information regarding the matched businesses which is then cached by registry server 130. Next, service entries are retrieved from registry 170 during retrieve service entry operation 615. For example, registry server 130 requests service entries from directory server 150, and directory server 150 polls the service sub-trees of each identified business, and sends information regarding each service entry to registry server 130. A service entry may include, for example, service information regarding a service offered directly by the business under which it is stored and/or a service key which is useful in identifying a service provided of another business for the business under which the service key is stored.

FIG. 6 shows an operational loop beginning after retrieve service entry operation 615 described above. The operation loop begins at begin loop operation 620, ends at end loop operation 645, and includes operations 625-640. For each retrieved service entry, the directory service determines if the service entry is a service projection during service projection decision 625. If the service entry is a service projection, registry server 130 requests a corresponding service key from registry 170 at directory server 150 during collect service key operation 640. If the service entry is not a service projection, registry server 130 requests the corresponding service from registry 170 at directory server 150 during collect service operation 630. After either of collect service operation 630 and collect service key operation 640, processing continues at end loop operation 645, returning to begin loop operation 620 if additional service entries are to be processed. As noted previously regarding loops such as this, other embodiments may generate separate objects to collect the services and service keys for each service entry, and the processing described above may occur not in succession but in parallel or without regard to order.

After the functionality of the operational loop completes at end loop operation 645, the service entries for the service projections identified during the operational loop are retrieved during retrieve projected service entries operation 650. For example, if a service entry retrieved for the business during operation 615 was determined to be a service projection during decision 625, then the service key collected during operation 640 is used to retrieve the service entry from another business service subtree in registry 170. That is, the service key identifies a business service indirectly offered by the found business, but which is actually directly offered by another business or an agent of the other business, and the service key identifies the service entry of the more direct offering business which is then retrieved under the name of the found business. Registry server 130 can then return a businesslist message to the user at access system 180 which includes services offered by the found business both directly (identified by service nodes of registry 170) and indirectly (identified by service projection nodes of registry 170).

FIG. 7 is a flowchart showing an exemplary flow in which a service is found in registry 170. A find_service message is received at operation 710. For example, a directory service user may use access system 180 to send a message to registry server 130 to find a service which may be offered by any of a variety of organizations such as a business. Registry server in turn communicates with directory server 150 to find the service in registry 170.

After the find_service message is received at operation 710, the directory service determines whether a business key is provided in the message. For example, registry server 130 determines whether a business key was included as part of the find_service message. If a business key was not provided, service entries in registry 170 which match the service requested are collected during collect matching service entries operation 740. Resulting information (e.g., a list of services and the business which provide them) are returned via a servicelist message. For example, registry server 130 returns a servicelist message to access system 180 during return message operation 790.

If a business key was provided in the find_service message, the business node of the business identified by the business key is located in registry 170 during locate business entry operation 730. If the business entry is determined during found decision 750 to have not been found during locate operation 730, an error has occurred. Directory server 150 returns an indication of an error, for example, to registry server 130, which in turn provides a e_invalidkeypassed fault message to the user at access system 180. If the business entry is determined to have been found during decision 750, all matching service entries of the business are collected from registry 170 during collect operation 770. All matching service projections are also collected from registry 170 during collect operation 770. If service projections are collected during collect operation 770 for a first business, all service entries of other businesses which are identified by the collected service projections of the first business are collected from registry 170 during collect operation 780. After all of the service entries which match the request in the find_service message have been collected, a servicelist message is returned as described above. For example, resulting information (e.g., a list of services and the business which provide them) are returned via a servicelist message by registry server 130 to access system 180 during return message operation 790.

FIG. 8 is a flowchart showing an exemplary flow in which details regarding a specific business are discovered via a search of information stored in registry 170. A get_businessdetail message is received at operation 805. For example, a directory service user may use access system 180 to send a message to registry server 130 to find information regarding services offered by an organization such as a specifically identified business. Registry server in turn communicates with directory server 150 to find the business details in registry 170 and provide the resulting list of details to the user at access system 180.

After the get_businessdetail message is received at operation 805, a business key operational loop is entered for each business key included in the received message. The business key operation loop begins at begin loop operation 810, ends at end loop operation 875, and includes operations 815-870. As with other loops described herein, other embodiments may generate separate objects or processes to collect the requested information as applicable, and the processing described herein may occur in certain embodiments in a non-iterative fashion or otherwise not in succession, but rather in a parallel fashion, or otherwise without regard to order, as appropriate.

In the embodiment shown in FIG. 8, the directory service retrieves a business entry for each business key in the message during retrieve operation 815. If a corresponding business entry is not found, an error occurs. For example, if registry server 130 determines that there is no business entry corresponding to the business key during found decision 820, an e_invalidkeypassed fault message is returned to access system 180 during return error operation 830. If a corresponding business entry is found, service entries in the service sub-tree of the business entry are retrieved from registry 170 during retrieve service entries operation 840.

After retrieve service entries operation 840, a service entry operational loop is entered for each retrieved service entry. The service entry operation loop begins at begin loop operation 845, ends at end loop operation 865, and includes operations 850, 855 and 860. In the embodiment shown in FIG. 8, the directory service determines if each service entry is a service projection. For example, registry server 130 (or directory server 150) determines whether a node within a service subtree of a business organization is a service or a service projection during service projection decision 850. If the service entry is a service, information regarding the service is collected during collect service operation 855. If the service entry is determined to be a service projection, the service key stored at the service projection node is collected during collect service key 860. After either of operations 855 and 860, processing continues at end loop operation 865, returning to begin loop operation 845 if additional service entries are to be processed. Upon completion of the service entry loop, the service entries identified by the collected service keys are retrieved from their respective business and service sub-trees of registry 170. The above described steps beginning at retrieve business entry 815 are then repeated if necessary for successive business keys. The business key loop is exited at end loop operation 875 when there are no further business keys to process. The results of the get business details flow are then returned. For example, registry server 130 returns information regarding the services offered by or through specific businesses in a businessdetail message sent to access system 130 during return message operation 880.

The above description is intended to describe at least one embodiment of the invention. The above description is not intended to define the scope of the invention. Rather, the scope of the invention is defined in the claims below. Thus, other embodiments of the invention include other variations, modifications, additions, and/or improvements to the above description.

For example, those skilled in the art will recognize that boundaries between the functionality of the above described operations are merely illustrative. The functionality of multiple operations may be combined into a single operation, and/or the functionality of a single operations may be distributed in additional operations. Moreover, alternative embodiments may include multiple instances of a particular operation, and the order of operations may be altered in various other embodiments.

Although the foregoing methodology is expressed in terms of operations, the methodology may be implemented using any of a variety of means, including object oriented programming which assigns functional objects to perform the operations described herein. For example, each message received by registry server 130 may be received by a message handling system which includes various factories for generating various function specific objects to handle the requested functionality of each received message. One type of message handling system is described in U.S. patent application Ser. No. 10/201,102, entitled “Runtime Versioning of Information Processing Systems,” filed on Jun. 28, 2002, naming William Drake, Kent Spaulding and David Gadbois as inventors, and which is incorporated by reference herein in its entirety. In one embodiment, the operations are encoded as software modules as part of or accessible by the various servers discussed herein using appropriate programming languages such as Java or another appropriate such as Java or another appropriate language and the data are encoded using XML or another markup language or the like.

The above described embodiments are described with reference to the architectural blocks of FIG. 1 and the DIT of FIG. 2 for the sake of convenience. Notwithstanding any above exemplary description in which a particular architectural block is chosen to perform all or part of an operation, other architectural blocks may perform all or part of the described functionality of such operations. For example, although registry server 130 is described as driving much of the operational functionality of the various process flows, some of the functionality performed by registry server may be offloaded on to a smart directory server system configured to quickly perform the functionality at the directory server, thereby decreasing the amount of network traffic between registry server 130 and directory server 150.

The operations discussed herein may consist of steps carried out by system users, hardware modules and/or software modules. In other embodiments, the operations of FIGS. 3-8, for example, are directly or indirectly representative of software modules (e.g., factories, objects, routines, or other partitional software designations) resident on a computer readable medium and/or resident within a computer system and/or transmitted to the computer system as part of a computer program product. Thus, the operations referred to herein may correspond to modules or portions of modules (e.g., software, firmware or hardware modules, or combinations thereof). Accordingly, the boundaries between such modules are also merely illustrative and alternative embodiments may merge modules or impose an alternative decomposition of functionality of modules. For example, the modules discussed herein may be decomposed into submodules to be executed as multiple computer processes. Moreover, alternative embodiments may combine multiple instances of a particular module or submodule. Also, there may be overlap of modules. For example, a module for performing a first function may include software instructions or code for performing a particular subfunction of the first function or the entire first function, such software instructions or code also capable of being used by other modules.

The above described method, the operations thereof and modules therefor may be executed on a computer system or systems configured to execute the operations of the method and/or may be executed from computer-readable media. Computer systems may be found in many forms including but not limited to mainframes, minicomputers, servers, workstations, personal computers, notepads, personal digital assistants, various wireless devices and embedded systems, just to name a few. A typical computer system includes at least one processing unit, associated memory and a number of input/output (I/O) devices. A computer system processes information according to a program and produces resultant output information via I/O devices. A program is a list of instructions such as a particular application program and/or an operating system. A computer program is typically stored internally on computer readable storage media or transmitted to the computer system via a computer readable transmission medium. A computer process typically includes an executing (running) program or portion of a program, current program values and state information, and the resources used by the operating system to manage the execution of the process. A parent computer process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

The method(s) described above may be embodied in a computer-readable medium for configuring a computer system to execute the method. One such computer-readable medium is directory server 150. The computer readable media may be permanently, removably or remotely coupled to system 100 or another system. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; spintronic memories, volatile storage media including registers, buffers or caches, main memory, RAM, etc.; and data transmission media including permanent and intermittent computer networks, point-to-point telecommunication equipment, carrier wave transmission media, the Internet, just to name a few. Other new and various types of computer-readable media may be used to store and/or transmit the software modules discussed herein.

It is to be understood that the architecture(s) depicted herein (e.g., in FIG. 1) are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

Because the above detailed description is exemplary, when “one embodiment” is described, it is an exemplary embodiment. Accordingly, the use of the word “one” in this context is not intended to indicate that one and only one embodiment may have a described feature. Rather, many other embodiments may, and often do, have the described feature of the exemplary “one embodiment.” Thus, as used above, when the invention is described in the context of one embodiment, that one embodiment is one of many possible embodiments of the invention.

Notwithstanding the above caveat regarding the use of the words “one embodiment” in the detailed description, it will be understood by those within the art that if a specific number of an introduced claim element is intended in the below claims, such an intent will be explicitly recited in the claim, and in the absence of such recitation no such limitation is present or intended. For example, in the claims below, when a claim element is described as having “one” feature, it is intended that the element be limited to one and only one of the feature described. Furthermore, when a claim element is described in,the claims below as including or comprising “a” feature, it is not intended that the element be limited to one and only one of the feature described. Rather, for example, the claim including “a” feature reads upon an apparatus or method including one or more of the feature in question. That is, because the apparatus or method in question includes a feature, the claim reads on the apparatus or method regardless of whether the apparatus or method includes another such similar feature. This use of the word “a” as a nonlimiting, introductory article to a feature of a claim is adopted herein by Applicants as being identical to the interpretation adopted by many courts in the past, notwithstanding any anomalous or precedential case law to the contrary that may be found. Similarly, when a claim element is described in the claims below as including or comprising an aforementioned feature (e.g., “the” feature), it is intended that the element not be limited to one and only one of the feature described merely by the incidental use of the definite article.

Furthermore, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

While particular embodiments of the present invention have been shown and described, it will be obvious to those skilled in the art that, based upon the teachings herein, various modifications, alternative constructions, and equivalents may be used without departing from the invention claimed herein. Consequently, the appended claims encompass within their scope all such changes, modifications, etc. as are within the spirit and scope of the invention. Furthermore, it is to be understood that the invention is solely defined by the appended claims. The above description is not intended to present an exhaustive list of embodiments of the invention. Unless expressly stated otherwise, each example presented herein is a nonlimiting or nonexclusive example, whether or not the terms nonlimiting, nonexclusive or similar terms are contemporaneously expressed with each example. Although an attempt has been made to outline some exemplary embodiments and exemplary variations thereto, other embodiments and/or variations are within the scope of the invention as defined in the claims below.

What is claimed is:

1. An apparatus comprising a directory information tree encoded in a memory, the directory information tree comprising:
first and second entity nodes corresponding to first and second entities, respectively;
a first entity service node corresponding to the first entity node in the directory information tree, the first entity service node including information regarding a service offered by the first entity; and
a second entity service projection node corresponding to the second entity node in the directory information tree, the second entity service projection node including information regarding the first entity service node.

2. The apparatus of claim 1 further comprising a directory information processing system, the directory information processing system comprising:
the memory;
the directory information tree; and
directory server software for accessing the directory information tree in the memory responsive to messages from another information processing system.

3. The apparatus of claim 2 further comprising a directory service, the directory service comprising:
at least one directory server system including the directory information processing system; and
at least one registry server coupled to the directory server system, the registry server being coupled to access at least one of the first entity service node and the second entity service projection node in the directory information tree.

4. The apparatus of claim 3 wherein the at least one registry server is coupled to the directory server system to initiate modification of at least one of the first entity service node and the second entity service projection node in the directory information tree.

5. The apparatus of claim 4 wherein the at least one registry server is coupled to receive messages from directory service users, and is configured to access the directory server system responsive to the messages from the directory service users.

6. The apparatus of claim 1 wherein:
the first and second entities are commercial entities;
the first entity service node includes information regarding a business service offered by the first entity.

7. A method of processing information regarding services offered through a plurality of entities, the method comprising:
configuring a directory information tree to store service information in relation to a first entity, the service information regarding a service to be provided directly by the first entity; and
configuring the directory information tree to store service projection information in relation to a second entity, the service projection information regarding the service to be provided by the first entity.

8. The method of claim 7 further comprising:
providing the directory information tree; and
providing a software module capable of accessing the directory information tree to manipulate the service and service projection information.

9. The method of claim 7 further comprising:
receiving a message indicative of a request to save information regarding a service of an entity;
accessing the directory information tree to save the service in a node as part of a sub-tree of a node related to the entity if the service is to be provided by the entity; and
accessing the directory information tree to save a service projection in a node as part of a sub-tree of a node related to the entity if the service is to be provided by another entity.

10. The method of claim 7 further comprising:
receiving a message indicative of a request to find a business providing a service;
accessing the directory information tree to locate business nodes coupled to a service node related to the service;
for each located business, retrieving information regarding the service from the service node if the service node is not a service projection node;
for each located business, retrieving the information regarding the service from another service node identified by the service node if the service node is a service projection node.

11. The method of claim 7 further comprising:
receiving a message indicative of a request to find a service;
determining if an entity key identifying an entity is provided with the message;
collecting information regarding the service from service nodes coupled to an entity node representative of the entity if the entity key is provided with the message;
collecting information regarding the service from service nodes coupled to any of a plurality of entity nodes if the entity key is not provided with the message.

12. The method of claim 7 further comprising:
receiving a message indicative of a request to retrieve details regarding an entity;
retrieving from the directory information tree service information regarding services related to the entity from a service node coupled to an entity node representative of the entity;
if a service node coupled to the entity node representative of the entity includes a service key, retrieving from the directory information tree service information regarding services provided by another entity from a service node which is coupled to the other entity node and which is identified by the service key.

13. An apparatus for processing information regarding services offered through a plurality of entities, the apparatus comprising software modules encoded on a computer readable medium, the software modules comprising:
a software module for configuring a directory information tree to store service information in relation to a first entity, the service information regarding a service to be provided directly by the first entity; and
a software module for configuring the directory information tree to store service projection information in relation to a second entity, the service projection information regarding the service to be provided by the first entity.

14. The apparatus of claim 13 wherein the software modules further comprise:
a software module for providing the directory information tree; and
a software module for providing a software module capable of accessing the directory information tree to manipulate the service and service projection information.

15. The apparatus of claim 13 wherein the software modules further comprise:
a software module for receiving a message indicative of a request to save information regarding a service of an entity;
a software module for accessing the directory information tree to save the service in a node as part of a sub-tree of a node related to the entity if the service is to be provided by the entity and for accessing the directory information tree to save a service projection in a node as part of a sub-tree of a node related to the entity if the service is to be provided by another entity.

16. The apparatus of claim 13 wherein the software modules further comprise:
a software module for receiving a message indicative of a request to find a business providing a service;
a software module for accessing the directory information tree to locate business nodes coupled to a service node related to the service;
a software module for retrieving information regarding the service for each located business from the service node if the service node is not a service projection node and for retrieving the information regarding the service from another service node identified by the service node for each located business if the service node is a service projection node.

17. The apparatus of claim 13 wherein the software modules further comprise:
a software module for receiving a message indicative of a request to find a service;
a software module for determining if an entity key identifying an entity is provided with the message;
a software module for collecting information regarding the service from service nodes coupled to an entity node representative of the entity if the entity key is provided with the message and for collecting information regarding the service from service nodes coupled to any of a plurality of entity nodes if the entity key is not provided with the message.

18. The apparatus of claim 13 wherein the software modules further comprise:
a software module for receiving a message indicative of a request to retrieve details regarding an entity;
a software module for retrieving from the directory information tree service information regarding services related to the entity from a service node coupled to an entity node representative, of the entity and, if a service node coupled to the entity node representative of the entity includes a service key, for retrieving from the directory information tree service information regarding services provided by another entity from a service node which is coupled to the other entity node and which is identified by the service key.

19. The apparatus of claim 13 further comprising the directory information tree encoded in a memory, the directory information tree configurable to store first and second entity nodes corresponding to the first and second entities, respectively, a first entity service node corresponding to the first entity, and a second entity service projection node corresponding to the second entity.

20. An apparatus for processing information regarding services offered through a plurality of entities, the apparatus comprising:
means for configuring a directory information tree to store service information in relation to a first entity, the service information regarding a service to be provided directly by the first entity; and
means for configuring the directory information tree to store service projection information in relation to a second entity, the service projection information regarding the service to be provided by the first entity.

21. The apparatus of claim 20 further comprising:
means for receiving a message indicative of a request to save information regarding a service of an entity;
means for accessing the directory information tree to save the service in a node as part of a sub-tree of a node related to the entity if the service is to be provided by the entity and for accessing the directory information tree to save a service projection in a node as part of a sub-tree of a node related to the entity if the service is to be provided by another entity.

22. The apparatus of claim 20 further comprising:
means for receiving a message indicative of a request to find a business providing a service;
means for accessing the directory information tree to locate business nodes coupled to a service node related to the service;
means for retrieving information regarding the service for each located business from the service node if the service node is not a service projection node and for retrieving the information regarding the service from another service node identified by the service node for each located business if the service node is a service projection node.

23. The apparatus of claim 20 further comprising:
means for receiving a message indicative of a request to find a service;
means for determining if an entity key identifying an entity is provided with the message;
means for collecting information regarding the service from service nodes coupled to an entity node representative of the entity if the entity key is provided with the message and for collecting information regarding the service from service nodes coupled to any of a plurality of entity nodes if the entity key is not provided with the message.

24. The apparatus of claim 20 further comprising:
means for receiving a message indicative of a request to retrieve details regarding an entity;
means for retrieving from the directory information tree service information regarding services related to the entity from a service node coupled to an entity node representative of the entity and, if a service node coupled to the entity node representative of the entity includes a service key, for retrieving from the directory information tree service information regarding services provided by another entity from a service node which is coupled to the other entity node and which is identified by the service key.
